(19) United States
(12) Patent Application Publication
(10) Pub. No.: US 2014/0012695 A1
(43) Pub. Date: Jan. 9, 2014

(54) BATCH AUCTION

(71) Applicants: Jukka TUOHIMAA, Oulu (FI); Janne RASANEN, Tyrnava (FI)

(72) Inventors: Jukka TUOHIMAA, Oulu (FI); Janne RASANEN, Tyrnava (FI)

(73) Assignee: APOCALYPSE MARKET OY, Oulu (FI)

(21) Appl. No.: 13/541,235

(22) Filed: Jul. 3, 2012

(51) Int. Cl. G06Q 30/08

(52) U.S. Cl. 705/26.3

(57) ABSTRACT

An auction of a batch with a deadline is disclosed. An apparatus includes one or more processors, and one or more memories storing instructions. The instructions, when executed by the one or more processors, cause the apparatus to set a batch sale function determining pricing control for a batch and for a plurality of items belonging to the batch before an auction with a deadline commences, and to modify at least one price of at least one item belonging to the batch during the auction by the batch sale function.

### FIELD

The invention relates to an auction of a batch with a deadline.

### BACKGROUND

Popularity of auctions is as great as ever, and it may even be on the rise due to various types of online auctions. As auctions are based on centuries old traditions, further sophistication is clearly desirable in order to ensure smooth trade of goods with right price levels.

### BRIEF DESCRIPTION

The present invention seeks to provide an improved apparatus and an improved method.

According to an aspect of the present invention, there is provided an apparatus comprising: one or more processors, and one or more memories storing instructions, that, when executed by the one or more processors, cause the apparatus to: set a batch sale function determining pricing control for a batch and for a plurality of items belonging to the batch before an auction with a deadline commences; and modify at least one price of at least one item belonging to the batch during the auction by the batch sale function.

According to another aspect of the present invention, there is provided a method comprising: setting a batch sale function determining pricing control for a batch and for a plurality of items belonging to the batch before an auction with a deadline commences; and modifying at least one price of at least one item belonging to the batch during the auction by the batch sale function.

### LIST OF DRAWINGS

Example embodiments of the present invention are described below, by way of example only, with reference to the accompanying drawings, in which

FIGS. 1, 2, 3, 4, 5, 6, 7 and 8 illustrate example embodiments of apparatuses relating to an auction;

FIG. 9 is a signal sequence chart illustrating an example embodiment of communication relating to an auction;

FIGS. 10, 11, 12, 13, 14, 15, 16, 17 and 18 illustrate example embodiments relating to pricing control of an auction; and

FIG. 19 is a flow chart illustrating example embodiments of a method.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

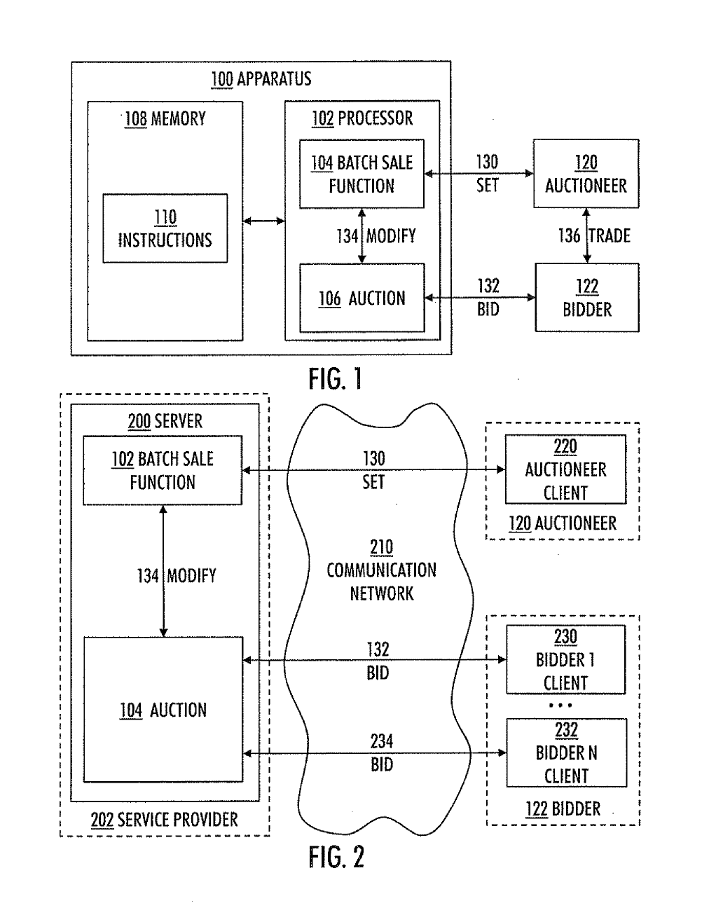

FIG. 1 illustrates an example embodiment of an apparatus 100 implementing an auction with a deadline for a batch. The apparatus 100 may be located in a fixed location, such as a department store, boutique or kiosk, or it may be available online through a communication network.

In principle, the auction is a process of buying and selling items by offering them up for bid, taking bids, and then selling the items to the highest bidder. The auction may refer to any mechanism or set of trading rules for exchange. Consequently, many variations may be implemented to the basic auction process. The introduction of the deadline brings forth some further characteristics, as well as an online auction held over the Internet, or a descending Dutch auction (also known as a reverse auction). These and other modifications will be described in connection with the example embodiments.

A plurality of similar or different items belongs to the batch. An item may refer to a sales item (=an itemized product that participates in a sales process) such as a good (=a tangible commodity such as a product and material), or a service (=an intangible commodity). In effect, the item may be any material or immaterial item that may be sold in an auction.

An auctioneer 120 is a person or an entity wishing to sell the batch in the auction, i.e., auctioneer is the seller of the batch. A bidder 122 is a person or an entity wishing to buy an item belonging to the batch, i.e. the bidder 122 may become a buyer of an item provided that the auctioneer 120 accepts the bid. The resulting (bilateral) trade 136 is the transfer of ownership of the item from the auctioneer 120 to the bidder 122, wherein the auctioneer 120 gets something (usually money or credit) in exchange from the bidder 122. The item may be delivered from the auctioneer 120 to the bidder 122 in person, by mail, or by a courier service, for example. In some cases no physical item is delivered. The transfer of ownership may also be permanent or valid only for a predetermined time period. In any case, the terms and conditions of the trade 136 determine the way the trade 136 affects the ownership of the item(s).

The apparatus 100 comprises one or more processors 102, and one or more memories 108 storing instructions 110. The instructions 110, when executed by the one or more processors 102, cause the apparatus 100 to set 130 a batch sale function 104 determining pricing control for a batch and for a plurality of items belonging to the batch before an auction 106 with a deadline commences, and modify 134 at least one price of at least one item belonging to the batch during the auction 106 by the batch sale function 104.

In an example embodiment, the one or more memories 108 further store instructions 110, that, when executed by the one or more processors 102, cause the apparatus 100 to cause the auction 106 of the batch such that buyer candidates consider items as separate. In effect, the auctioneer 120 only knows which items belong to the batch, and the bidder 122 may only see separate items. But in some cases it may be useful that the buyer candidates become aware of the items forming a batch.

The processor 102 and the memory 108 may be implemented by an electronic circuitry. When designing the implementation of the processor 102 and the memory 108, a person skilled in the art will consider the requirements set for the size and power consumption of the apparatus 100, the necessary processing capacity, production costs, and production volumes, for example.

The term ‘processor’ 102 refers to a physical device that is capable of processing data in a computer or other (digital) electronic device. Depending on the processing power needed, the apparatus 100 may comprise several processors 102 such as parallel processors or one or more multicore processors. A non-exhaustive list of implementation techniques for the processor 102 includes, but is not limited to: logic components, standard integrated circuits, application-specific integrated circuits (ASIC), system-on-a-chip (SoC), application-specific standard products (ASSP), microprocessors, digital signal processors, special-purpose computer chips, and field-programmable gate arrays (FPGA).

The term ‘memory’ 108 refers to a physical device that is capable of storing the instructions 110 on a temporary or permanent basis for use in a computer or other digital electronic device. In an example embodiment, the term ‘memory’ 108 refers to working memory (also known as primary storage, main memory or internal storage) directly accessible to the processor 102. In an example embodiment, the working memory may be implemented as a random-access memory (RAM), such as a dynamic RAM, DRAM.

The term ‘instructions’ 110 refers to computer-executable program instructions, which may be contained in a computer program. The instructions 110 may be coded as a computer program using a programming language, which may be any high-level programming language, such as Ruby, C, C++, or Java, or a low-level programming language, such as a machine language, or an assembler. There are many ways to structure the program. In an example embodiment, the instructions of the program may be divided into functional modules, sub-routines, methods, classes, objects, applets, macros, etc., depending on the software design methodology and the programming language used. In modern programming environments, there are software libraries, i.e. compilations of ready-made functions, which may be utilized by the program for performing a wide variety of standard operations.

The apparatus 100 may be implemented to many different operating environments. A non-exhaustive list of implementation techniques for the apparatus 100 includes, but is not limited to: a computer, a server, a computer system, a cluster of computers, a network element in a cloud computing environment, a node of a peer-to-peer computing environment, a node of a hybrid peer-to-peer computing environment, any one of the previous operated by a service provider providing an on-line electronic environment for the auction, a particular network computer, a particular stand-alone computer, a server of a system providing an online environment for the auction of the batch by communicating with clients.

Let us next study some of these different implementation environments.

In FIG. 2, an online environment for the auction of the batch is illustrated. The apparatus 100 functionality is implemented by a server 200, an auctioneer client 220, and bidder clients 230, 232.

The server 200 may be operated by a service provider 202. The service provider 202 may be an independent supplier of auction services, such as an auction house, a telecom operator, a mobile operator, or any (online) company capable of providing the required services.

Note that a number of concurrent auctions may be held simultaneously, but, for the sake of clarity, only one such auction is illustrated in all Figures. Consequently, a number of auctioneers 120 may exist. In FIG. 2, there is a number N of bidders 122, and, consequently, of bidder clients 230, 232, wherein N is any integer greater than one.

As illustrated in FIG. 2, the communication, such as setting 130 of the batch sale function 102 and bids 132, 234 for the auction 104, is performed over a communication network 210. The communication network 210 may include various wired/wireless standard/non-standard/proprietary communication networks such as a computer network, a private network, an IP-based network (TCP/IP=Transmission Control Protocol/Internet Protocol), the Internet, the telephone network including the public switched telephone network, any mobile phone network, regardless of the generation (such as 2G, 3G, 4G, beyond 4G, etc.) such as GSM (Global System for Mobile Communications), GPRS (General Packet Radio Service), EGPRS (Enhanced GPRS), WCDMA (Wideband Code Division Multiple Access), UMTS (Universal Mobile Telephone System), 3GPP (The 3rd Generation Partnership Project), IMT (International Mobile Telecommunication), LTE (Long Term Evolution, LTE-A (LTE-Advanced), and other radio systems (in their present forms and/or in their evolution forms), such as WLAN (Wireless Local Area Network) based on IEEE (Institute of Electrical and Electronics Engineers) 802.11 standard or its evolution versions (IEEE 802.11ac etc.), WiMAX (Worldwide Interoperability for Microwave Access, or Wi-Fi, for example.

The server 200 is a part of the client-server computing model that acts as distributed application which partitions tasks or workloads between the provider of a resource or service, called server 200, and the service requester, called client 220, 230, 232. The server computer 200 is a host that is running one or more server programs which share their resources with clients 220, 230, 232.

The client 220, 230, 232 may request a server's content or service function relating to the auction 104 and its batch sale function 102. The client 220, 230, 232 therefore initiates a communication session with the server 200 which awaits incoming requests. The clients 220, 230, 232 may be implemented by a web browser, a desktop, a mobile application, or some other user interface application providing the user interface, while the batch sale function 104 and the auction 106 are provided by the server 200 at a remote location.

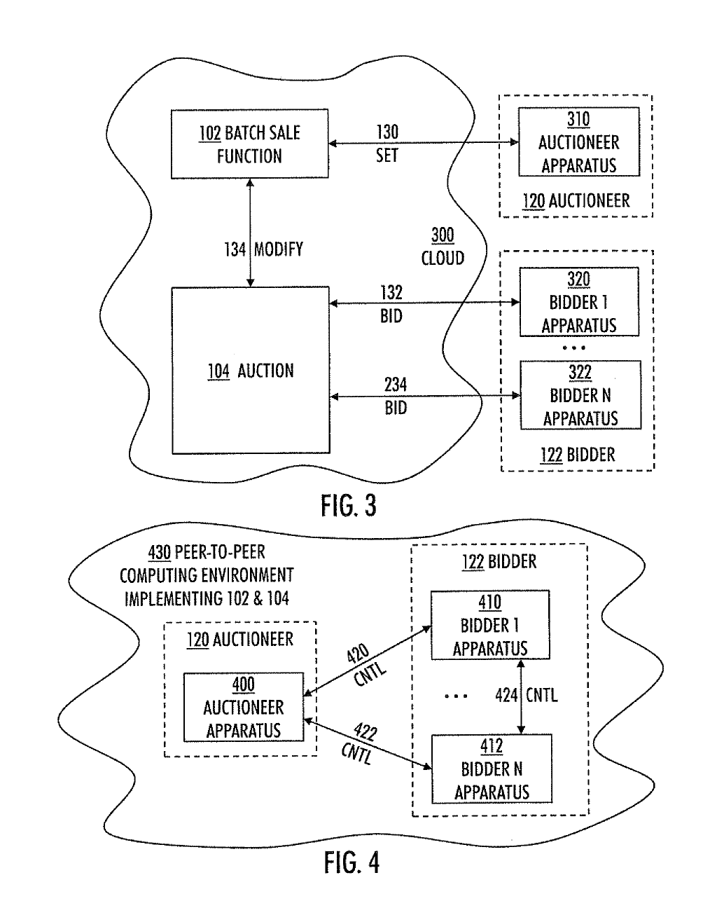

As illustrated in FIG. 3, the server functionality may also operate according to a cloud computing model, i.e., the batch sale function 102 and the auction 104 are implemented by a cloud 300. The cloud 300 delivers computing and storage capacity as a service to a heterogeneous community of client apparatuses 310, 320, 322 with a converged infrastructure and shared services. In principle, three types of cloud computing exist currently: Infrastructure as a Service (IaaS), Platform as a Service (PaaS), and Software as a Service (SaaS). All these types may be applied here. Using Infrastructure as a Service, the service provider 202 rents use of servers provided by one or more cloud providers. Using Platform as a Service, the service provider 202 rents use of servers and the required system software. Using Software as a Service, the service provider 202 also rents application software and databases. The cloud provider manages the infrastructure and platforms on which the applications 102, 104 run.

Also a hybrid of different implementations is possible, such as a combination of a one or more servers 200 operated by the service provider 202 and cloud computing resources 300 operated by an external computing service provider.

As illustrated in FIG. 4, additionally, or alternatively, the server may also operate according to the peer-to-peer (P2P) computing model. A pure peer-to-peer system consists of equal peer nodes that simultaneously function as both clients and servers. In a hybrid peer-to-peer system, a need for a special role is recognized: one or several nodes, but not all nodes, have a special role, which serves the other nodes of the peer-to-peer system. In FIG. 4, an auctioneer apparatus 400 may have the special role serving bidder apparatuses 410, 412. Additionally, the bidder apparatuses 410, 412 may also serve as a server to another client thereby relieving the processing load of the auctioneer apparatus 400. In peer-to-peer computing, control communication 420, 422, 424 is required between the peers 400, 410, 412, so that altogether the peer-to-peer computing environment 430 implements the described apparatus functionality 102, 104.

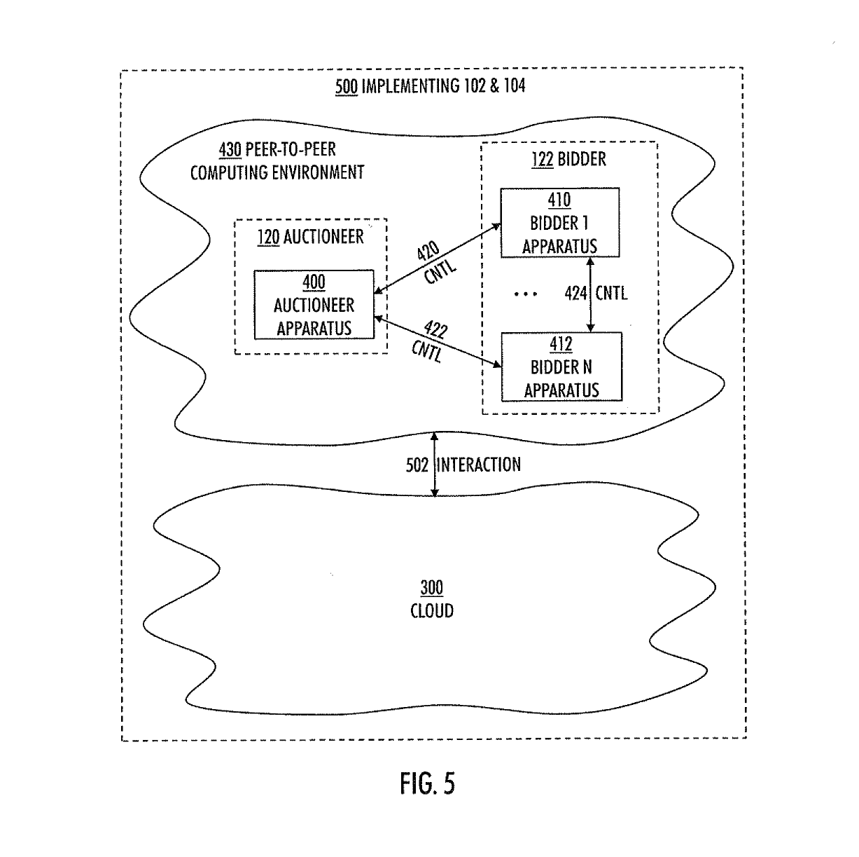

FIG. 5 illustrates a further hybrid implementation: the peer-to-peer computing environment 430 and the cloud 300 interact 502 to implement 500 the described apparatus functionality 102, 104.

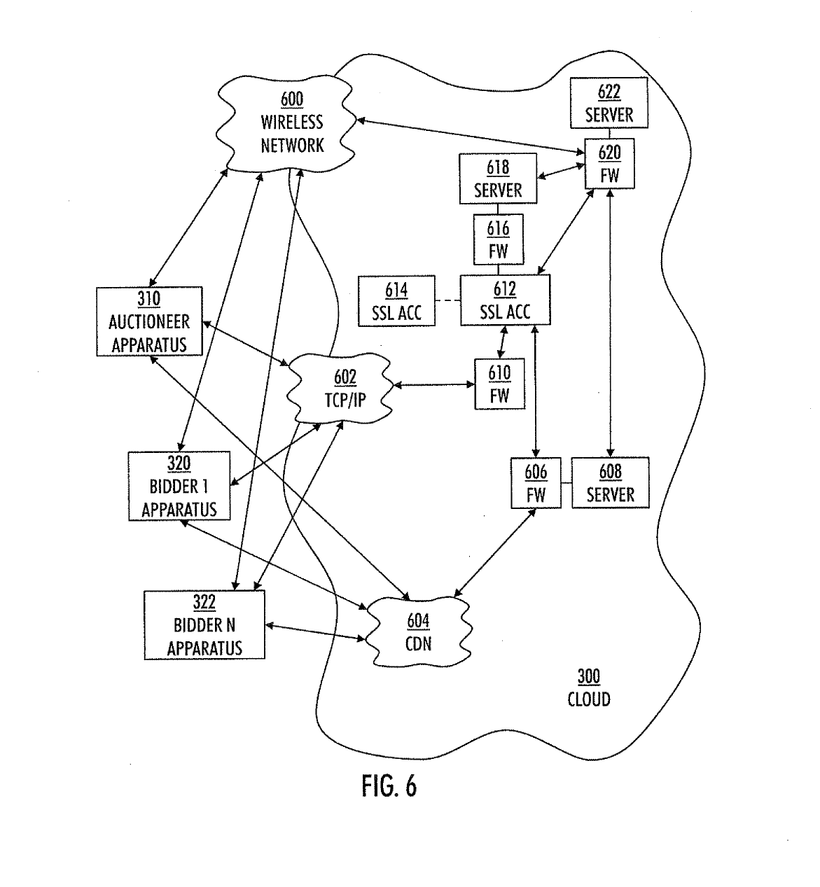

FIG. 6 illustrates a further example embodiment of the cloud 300 implementation. The client apparatuses 310, 320 communicate with servers 608, 618 over a wireless network 600, a TCP/IP network 602, and a content delivery network (CDN) 604.

CDN 604 is a large distributed system of servers deployed in multiple data centers in the Internet. A CDN operator gets paid by the auction 106 provider for delivering the content to the auctioneer 120 and the bidders 122. The CDN operator pays Internet service providers (ISP), carriers, and network operators for hosting its servers in their data centers. CDN 604 may offer a network location for the static content of the auction, i.e., storage for images, videos etc. of the auction (and its user interface) available world-wide.

Appropriate firewalls 606, 610, 616, 620 and load balancing SSL (Secure Socket Layer) accelerators 612, 614 may be utilized within the cloud 300 as needed to implement an efficient and data secure environment. The environment may include appropriate server(s) 622 implementing third party services and APIs (Application Programming Interface).

In FIG. 6, the distributed service 608, 618 is deployed in the cloud 300, and end users access the service through a web browser, a desktop, a mobile application, or other user interface application 310, 320, 322. End users are allowed to upload images, videos, documents, drawings, music or other legal media content and files to the auction service in order to make the items for sale more attractive. Naturally, the image, video, document, drawing or music may also itself be the object of the auction. The auction service may be designed with any design approach and associated service implementation that ensures prearranged level of operational performance and security. Third party services and APIs 622 may be involved. The auction service may invoke the user interface application 310, 320, 322 with a push notification or similar technology, which may include cooperation with third parties. Short message service SMS and multimedia messaging MMS technology or similar may be used to control auction as an optional extension. Real-time streaming technology providers such as television broadcast companies or other streaming technology providers may use the service API 622 to run an interactive sales event or auction through the communication channel(s) such as the Internet or SMS.

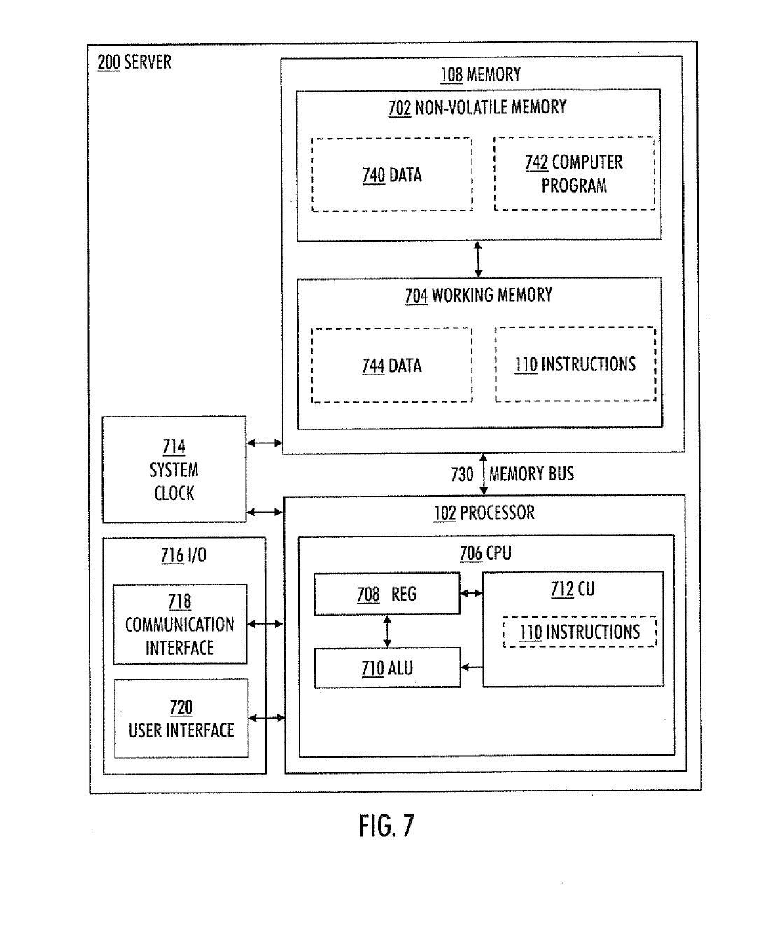

In an example embodiment illustrated in FIG. 7, the server 200 may be an electronic digital computer, which may comprise a non-volatile memory 702, a working memory 704, a central processing unit (CPU) 706, a system clock 714 and an input/output 716 including a communication interface 718 and a user interface 720. Naturally, the computer may comprise a number of other peripheral devices, not illustrated here for the sake of clarity.

In an example embodiment, the system clock 714 constantly generates a stream of electrical pulses, which cause the various transferring operations within the computer to take place in an orderly manner and with specific timing.

In an example embodiment, the processor 102 may be implemented as a microprocessor implementing functions of a central processing unit (CPU) 706 on an integrated circuit. The CPU 706 is a logic machine executing a computer program 742, which comprises program instructions 110.

The CPU 706 may comprise a set of registers 708, an arithmetic logic unit (ALU) 710, and a control unit (CU) 712. The control unit 712 is controlled by a sequence of instructions 110 transferred to the CPU 706 from the working memory 704. The working memory 704 is directly or indirectly connected to the CPU 706 via a memory bus 730 including two buses: an address bus and a data bus. The CPU 706 sends a memory address indicating the desired location of data (=data 744 relating to auction or instructions 114) number through the address bus, whereupon the CPU 706 reads or writes the data itself from/to the working memory 704 using the data bus.

The control unit 712 may contain a number of microinstructions for basic operations. The implementation of the microinstructions may vary, depending on the CPU design. The microprocessor 706 may also have an operating system (such as general-purpose operating system, a dedicated operating system of an embedded system, or a real-time operating system), which may provide the computer program 42 with system services. During running of the program 742, the instructions 110 are transferred via the memory bus 730 from the working memory 704 into the control unit 712, wherein usually a portion of the instructions 110 resides and controls the operation.

In an example embodiment, the non-volatile memory 702 retains the stored information even when not powered. Examples of non-volatile memory include read-only memory (ROM), flash memory, magnetic computer storage devices such as hard disk drives, and optical discs. As is shown in FIG. 7, the non-volatile memory 702 may store both data 740 of the auction and the computer program 742 comprising the instructions 110.

An example embodiment provides a computer readable medium comprising a set of instructions 110, which, when executed on the server 200 cause the server 200 to perform the required operations. In an example embodiment, the instructions 110 may be in source code form, object code form, or in some intermediate form. The computer-readable medium may comprise at least the following: any entity or device capable of carrying the instructions 110 to the server 200, a record medium, a computer memory, a read-only memory, an electrical carrier signal, a telecommunications signal, and a software distribution medium. In some jurisdictions, depending on the legislation and the patent practice, the medium may not be the telecommunications signal, i.e., the telecommunications signal is excluded. In an example embodiment, the medium may be a non-transitory computer readable storage medium.

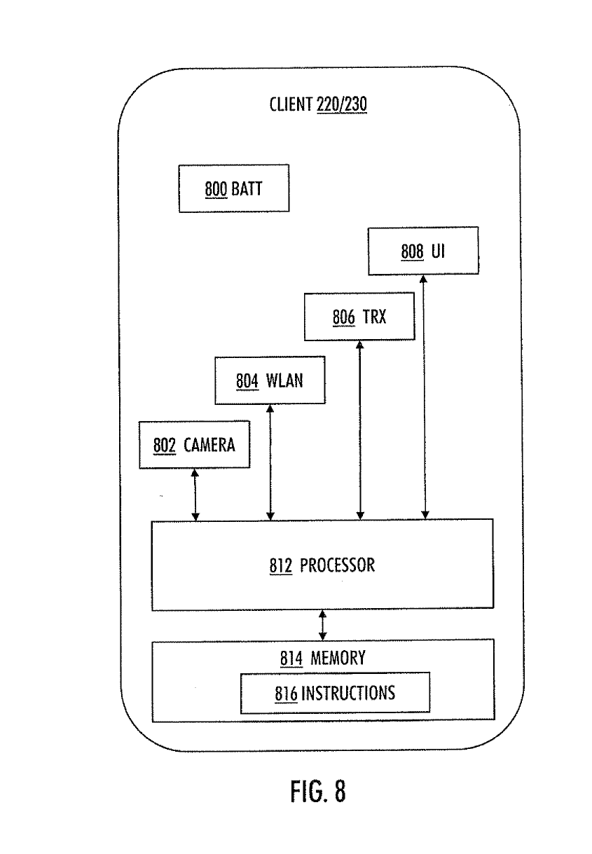

In an example embodiment illustrated in FIG. 8, the client 220/230 may be a similar electronic digital computer as illustrated in FIG. 7. A non-exhaustive list of the types of the client apparatus 220/230 includes: an electronic digital computer, a desktop computer, a portable computer, a laptop computer, a tablet computer, a smartphone, a mobile phone, a mobile terminal, or any other electronic apparatus capable of implementing an auction user interface. The client apparatus 220/230 may employ an operating system. A non-exhaustive list of the operating system includes, but is not limited to: Android, Microsoft Windows, Microsoft Windows Phone, Apple iOS, Apple Mac OS X, Linux, or Symbian, for example. In an example embodiment, the client 220/230 may be a mobile wireless communications terminal employing a cellular transceiver 806 and/or WLAN transceiver 804 capable of communicating with a wireless communication system, such as 210 illustrated in FIG. 2. In an example embodiment, the mobile client 220/230 may be a mobile phone comprising a memory 814 with instructions 816, a processor 812, a camera 802, a user interface 808, and a battery 800.

The user interface 808 may comprise a display, means for producing sound, a keyboard, and/or a keypad, for example. The display may be a liquid crystal display, for example, but it may also be implemented by any appropriate prior art technique, such as with an active-matrix organic light-emitting diode. The display may also incorporate other user interaction means, such as touch input, or haptic feedback, i.e. the display may be a touch screen. The means for producing sound may be a loudspeaker or a simpler means for producing beeps or other sound signals. The keyboard/keypad may comprise a complete (QWERTY) keyboard, a mere numeric keypad or only a few push buttons and/or rotary buttons. In addition, the user interface 808 may comprise other user interface elements, for example various means for focusing a cursor (mouse, track ball, various arrow keys, touch sensitive area etc.) or elements enabling audio control. A parameter, setting or command relating to the described processing of the batch sale function 104 and the auction 106 may be manipulated with the user interface 808.

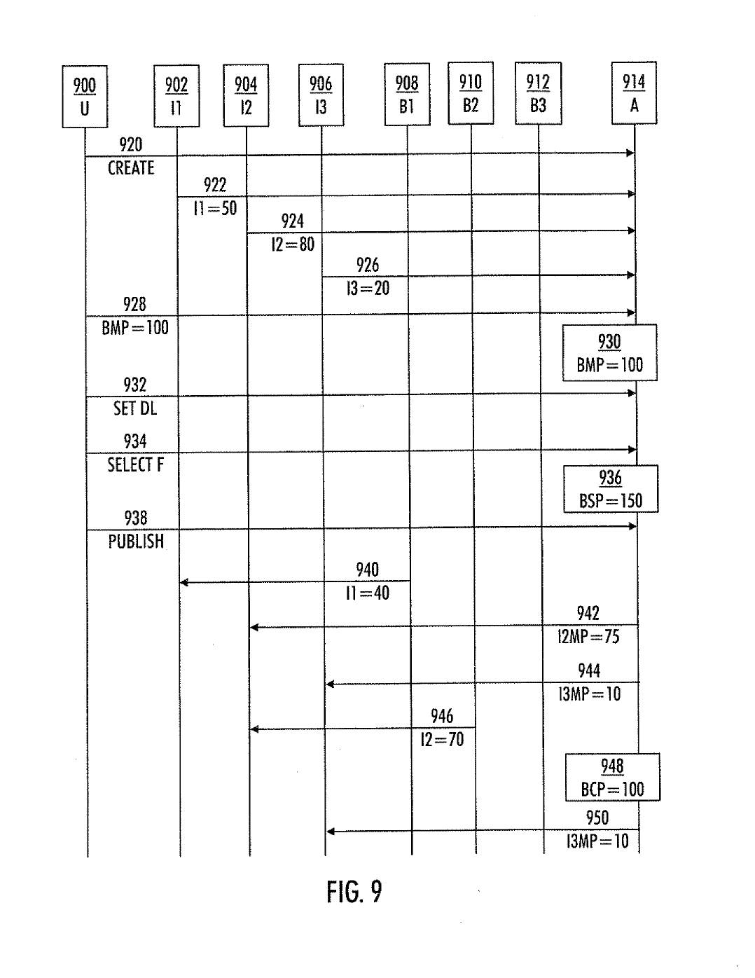

With reference to FIG. 9, let us next study an example embodiment of communication relating to an auction. A seller (U) 900 has three items to be sold with the auction system 914: item 1 (I1) 902, item 2 (I2) 904, and item 3 (I3) 906. There are three bidders: bidder 1 (B1) 908, bidder 2 (B2) 910 and bidder 3 (B3) 912.

In 920, the seller 900 creates the auction into the system 914.

In 922, the seller sets price of item 1 902 to 50 in the system 914.

In 924, the seller sets price of item 2 904 to 80 in the system 914.

In 926, the seller sets price of item 3 906 to 20 in the system 914.

In 928, the seller 900 sets a batch minimum price to 100 in the system 914.

In 930, the batch minimum price is saved for the batch in the system 914.

In 932, the seller 900 sets a deadline for the batch in the system 914.

In 934, the seller 934 selects a function in the system 914, which will determine the pricing control while selling the items belonging to the batch.

In 936, the system 914 sets the current total price to 150.

In 938, the seller 900 decides to publish the auction in the system 914.

In 940, the bidder 1 908 offers 40 for item 1 902.

In 942, the system 914 sets a new minimum price, 75, for the item 2 904.

In 944, the system 914 sets a new minimum price, 10, for the item 3 906.

In 946, the bidder 2 910 offers 70 for item 2 904.

In 948, the system 914 calculates new prices; the current total price for the batch is 100.

In 950, the system 914 sets a new minimum price, 10 for the item 3 906.

And so the auction continues until all items are sold or the deadline of the auction is reached.

In an example embodiment, the one or more memories 108 further store instructions 110, that, when executed by the one or more processors 102, cause the apparatus 100 to move the deadline either earlier or later during the auction 106 by the batch sale function 104. The auctioneer 120 may thus shorten or lengthen the auction 106 as required, in order to sell all the items, or to end the auction 106 sooner, for example.

The nature of the auction 106 is such that it will run automatically, or semi-automatically, assisted by user input from the auctioneer 120. Consequently, in an example embodiment, the one or more memories 108 further store instructions 110, that, when executed by the one or more processors 102, cause the apparatus 100 to perform at least one of the following:

cause reception of user input for setting the batch sale function 104 before the auction 106 commences;

cause reception of user input for adjusting the batch sale function 104 during the auction 106;

cause automatic adjustment of the batch sale function 104 during the auction 106;

cause automatic utilization of the batch sale function 104 during the auction 106;

cause automatic utilization of the batch sale function 104 during the auction 106, assisted by reception of user input for adjusting the batch sale function 104.

The batch sale function 104 determines the pricing control for the batch, and, consequently, many parameters relating to the pricing control may be set.

Let us first study minimum prices set for the batch sale function 104. In an example embodiment, the one or more memories 108 further store instructions 110, that, when executed by the one or more processors 102, cause the apparatus 100 to perform at least one of the following:

set the batch sale function 104 determining pricing control for the batch before the deadline-optimized auction 106 of the batch commences such that a minimum batch price during the auction 106 is set for the batch;

set the batch sale function 104 determining pricing control for the batch before the deadline-optimized auction 106 of the batch commences such that at least one minimum item price during the auction 106 is set for at least one item belonging to the batch;

set the batch sale function 104 determining pricing control for the batch before the deadline-optimized auction 106 of the batch commences such that minimum item prices during the auction 106 are set for all items belonging to the batch, and a minimum batch price during the auction 106 is automatically set for the batch based on the minimum item prices for all items belonging to the batch.

Next, let us study starting prices set for the batch sale function 104. In an example embodiment, the one or more memories 108 further store instructions 110, that, when executed by the one or more processors 102, cause the apparatus 100 to perform at least one of the following:

set the batch sale function 104 determining pricing control for the batch before the deadline-optimized auction 106 of the batch commences such that a starting batch price is set for the batch;

set the batch sale function 104 determining pricing control for the batch before the deadline-optimized auction 106 of the batch commences such that a starting item price is set for at least one item belonging to the batch;

set the batch sale function 104 determining pricing control for the batch before the deadline-optimized auction 106 of the batch commences such that starting item prices during the auction 106 are set for all items belonging to the batch, and a starting batch price during the auction 106 is automatically set for the batch based on the starting item prices for all items belonging to the batch.

The batch sale function 104 determines the pricing control according to some mathematical function: the pricing is changed over the time of the auction 105 according to the function.

The batch sale function 104 provides a pricing mechanism for the auction 106 to optimize prices of individual items during the auction 106 so that the whole batch of items will be sold. The batch sale function 104 expects that there is deadline, which is used to optimize starting price and minimum price for each individual item to be sold. Even if the batch sale function 104 is developed to be used on internet-based systems to provide real-time environment to each buyer for setting the price for items they are interested, it is not limited to be used on internet-based market places.

The batch sale function 104 changes pricing of each item during the time the batch is on sale. When any item receives bid which is higher than minimum price, the batch sale function 104 may decrease minimum prices for the rest of the items, which results in maintaining the minimum price of batch.

Pricing of each individual item on batch is following some function of the batch sale function 104, which may have unambiguous values for the whole duration of the auction 106. Additionally, the batch sale function 104 may be parameterized, so that it is easy to redefine pricing to meet the batch target price. If the function of the batch sale function 104 is such that it is not possible or it is difficult to meet the parameterization requirement, the batch sale function 104 may introduce a new function to be used from a certain point of time onwards.

In an example embodiment, each bidder 122 may see a pricing curve of each item of the batch generated with the batch sale function 104.

In principle, any suitable function may be utilized for the batch sale function 104. Functions used for item pricing and batch pricing may be developed during the auction 106 to have optimal pricing behavior.

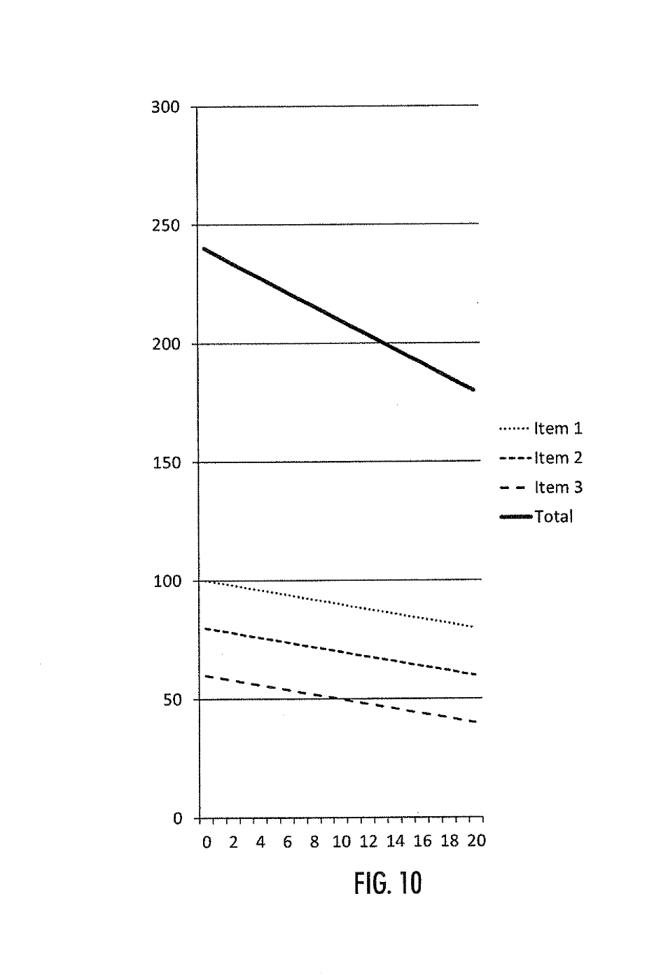

One simple function is a linear algorithm with decreasing prices during the auction 106 time, as illustrated in example embodiments of FIGS. 10, 11 and 12.

The batch sale function 104 utilizes for item pricing a linear function: item_price(t)=((price_max*(endtime−t))+(price_mix*(t))/(endtime−starttime). The total price for the batch is obtained with a sum function of all individual item prices.

As shown in FIG. 10, items 1, 2 and 3 follow linear pricing with the following attributes: price for item 1 starts with 100 and ends with 80, price for item 2 starts with 80 and ends with 60, and price for item 3 starts with 60 and ends with 40. Accordingly, the total price for the batch starts with 240 and ends with 180.

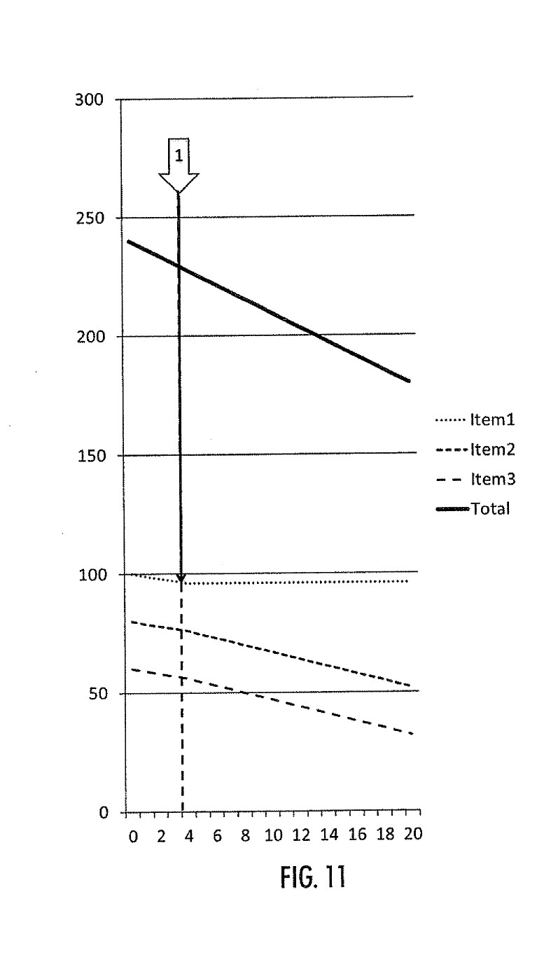

In FIG. 11, item 1 gets a bid of 96 at time 4, as illustrated with an arrow labeled with “1”. This bid will set the minimum price for item 1 for the remaining duration of the auction. Pricing functions for items 2 and 3 will also be modified: the batch sale function 104 divides price reduction equally to items 2 and 3. The equal division is only an example, a weighted function may be used instead, for example.

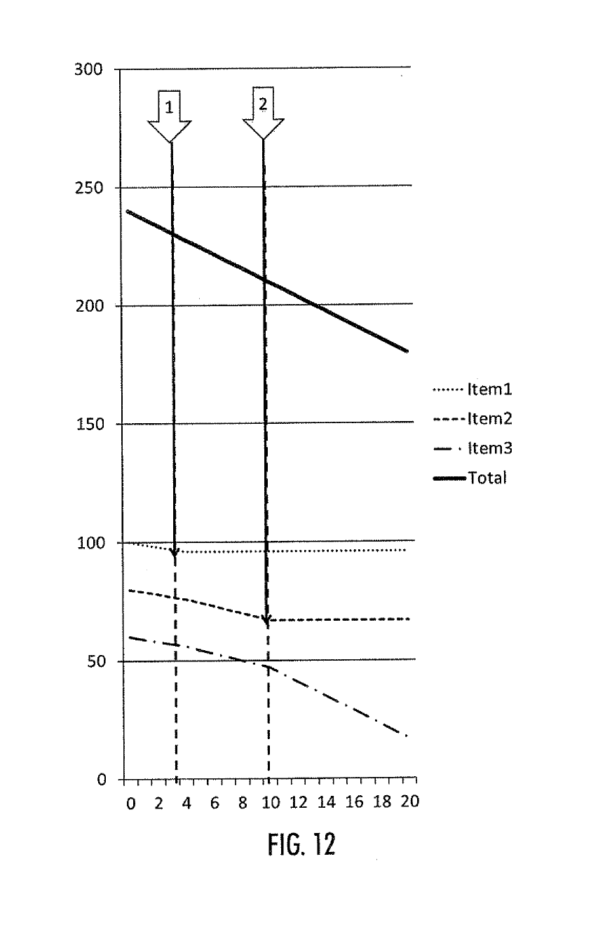

In FIG. 12, item 2 gets a bid of 67 at time 10, as illustrated with an arrow labeled with “2”. This bid will set the minimum price for item 2 for the remaining duration of the auction. Pricing function for item 3 will also be modified: as the last item, item 3 will get all the benefits during next pricing steps from the batch sale function 104.

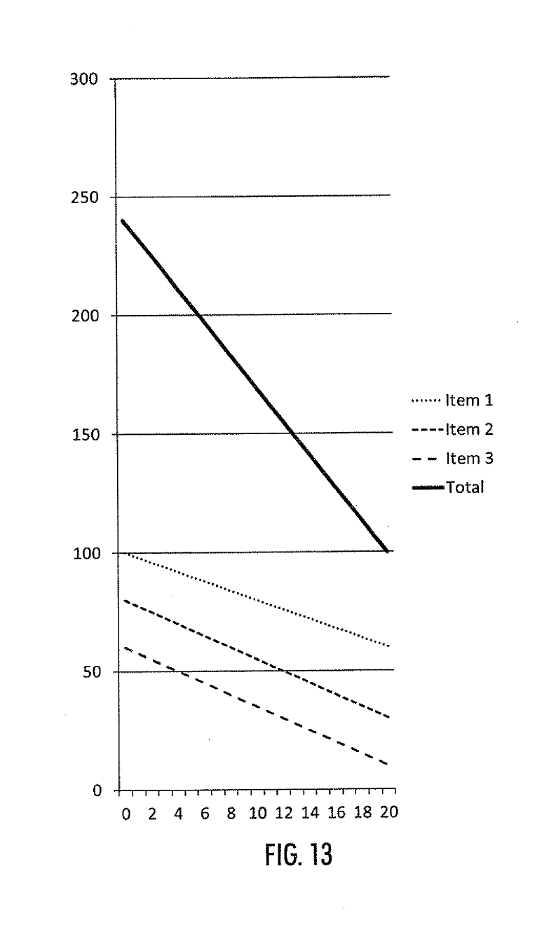

FIGS. 13, 14 and 15 illustrate another example embodiment of the batch sale function 104. Items 1, 2 and 3 follow linear pricing with the following attributes: price for item 1 starts with 100 and ends with 60, price for item 2 starts with 80 and ends with 30, and price for item 3 starts with 60 and ends with 10. Accordingly, the total price for the batch starts with 240 and ends with 100.

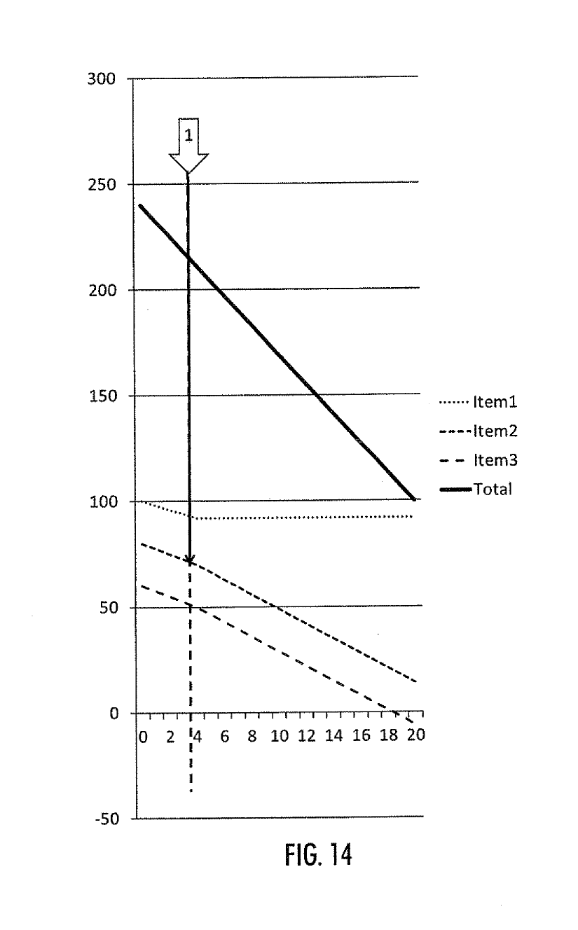

In FIG. 14, item 1 gets a bid 96 at time 4, as illustrated with an arrow labeled with “1”. This bid will set the minimum price for item 1 for the remaining duration of the auction. Pricing functions for items 2 and 3 will also be modified: the batch sale function 104 divides price reduction equally to items 2 and 3. Item 3 may already at the end of the auction be sold with currency value of −6.

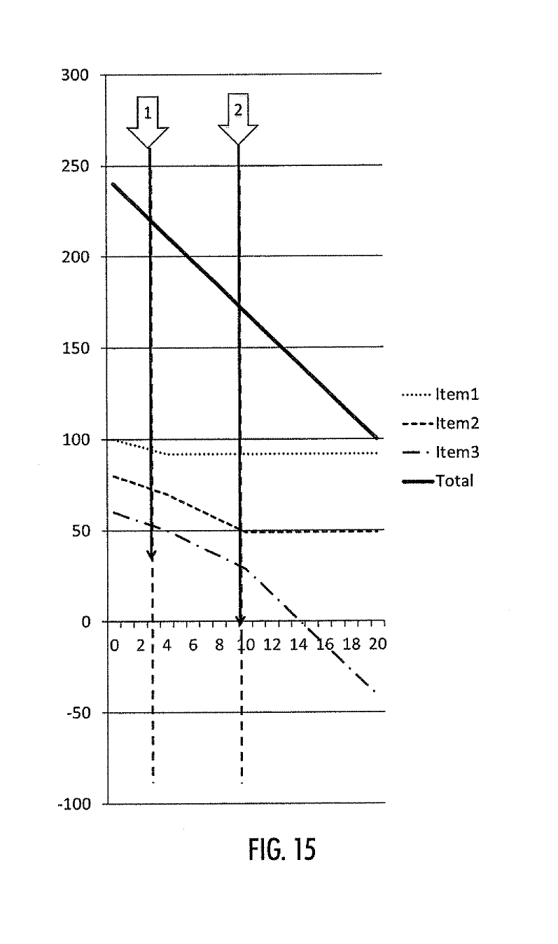

In FIG. 15, item 2 gets a bid of 67 at time 10, as illustrated with an arrow labeled with “2”. This bid will set the minimum price for item 2 for the remaining duration of the auction. Pricing function for item 3 will also be modified: as the last item, item 3 will get all the benefits during next pricing steps from the batch sale function 104. After item 1 and item 2 prices are secured, item 3 may be sold with a negative price of −41 at the end of the auction, which may be reasonable if the aim is to get rid all items of the batch.

In an example embodiment, the one or more memories 108 further store instructions 110, that, when executed by the one or more processors 102, cause the apparatus 100 to modify 134 the at least one price of the at least one item of the batch during the auction 106 by the batch sale function 104 such that at least one item price of at least one item belonging to the batch becomes negative, causing a payment to a buyer for buying the item with the negative price, but the prices of the items combined at least match a minimum batch price set for the batch during the auction 106.

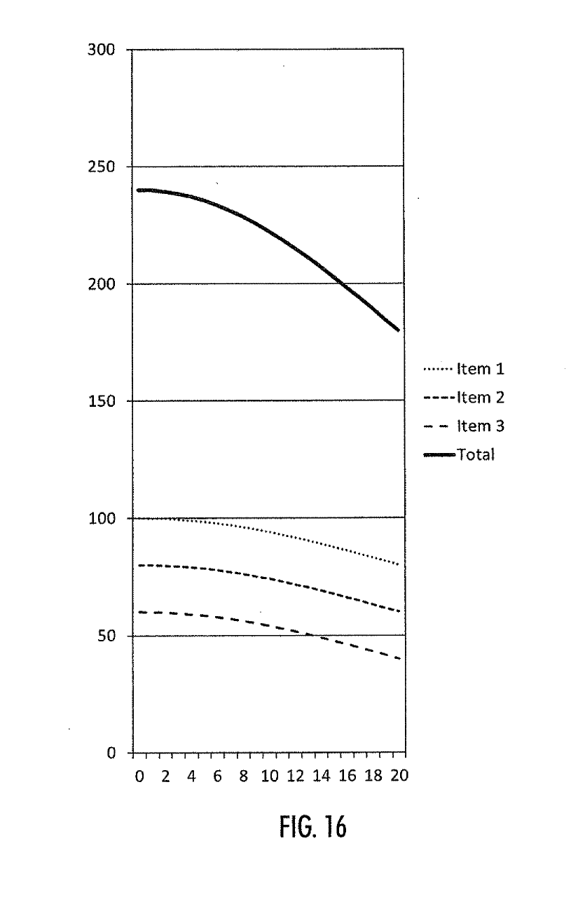

FIGS. 16, 17 and 18 illustrate another example embodiment of the batch sale function 104. The starting and minimum prices are the same as in FIGS. 10, 11 and 12, but, instead of a linear function, a non-linear function is used. The non-linear function increases the discount speed as the deadline approaching.

As shown in FIG. 16, items 1, 2 and 3 follow non-linear pricing with the following attributes: price for item 1 starts with 100 and ends with 80, price for item 2 starts with 80 and ends with 60, and price for item 3 starts with 60 and ends with 40. Accordingly, the total price for the batch starts with 240 and ends with 180.

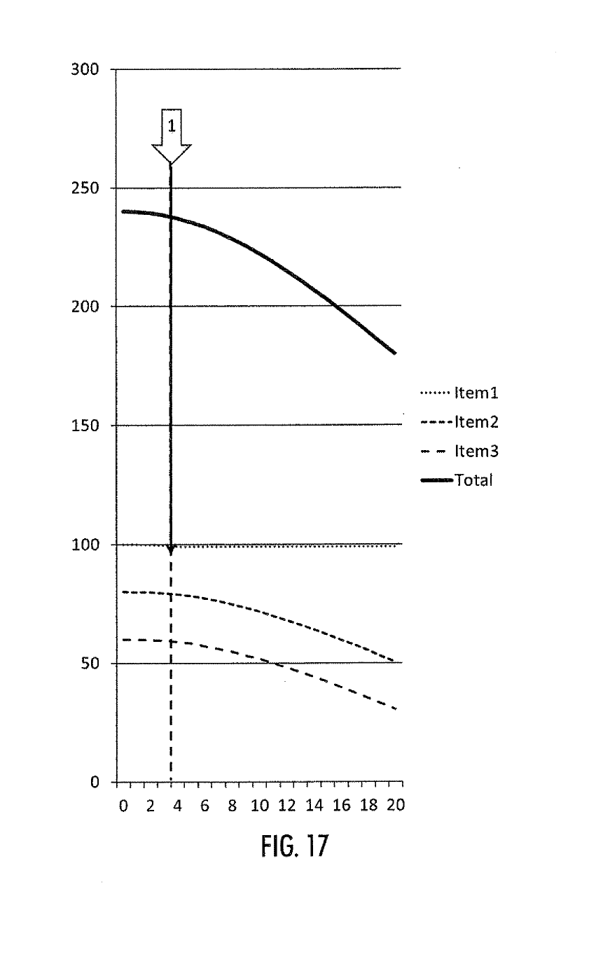

In FIG. 17, item 1 gets a bid of 96 at time 4, as illustrated with an arrow labeled with “1”. This bid will set the minimum price for item 1 for the remaining duration of the auction. Pricing functions for items 2 and 3 will also be modified: the batch sale function 104 divides price reduction equally to items 2 and 3.

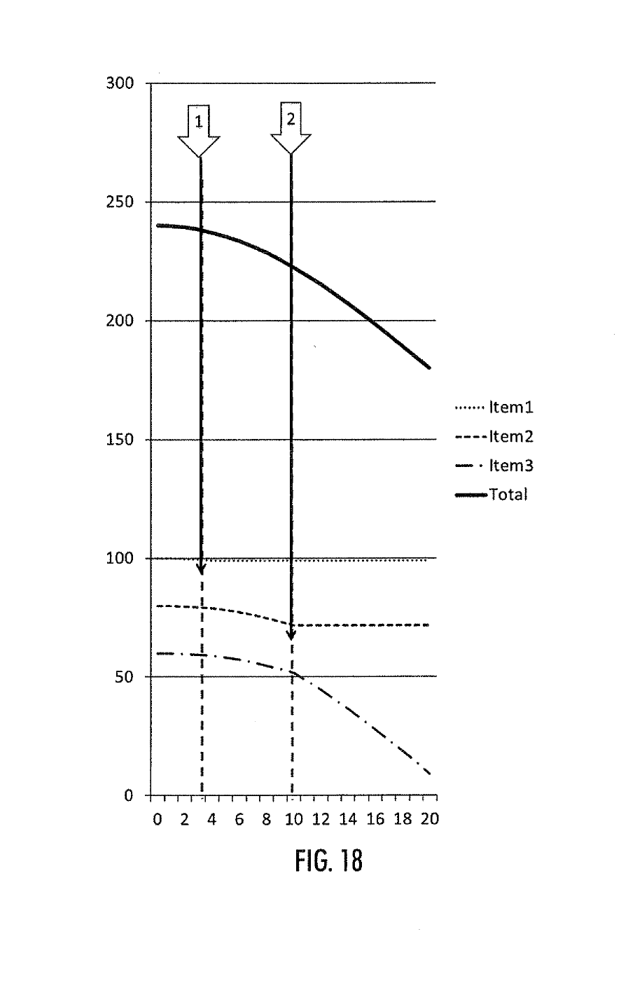

In FIG. 18, item 2 gets a bid of 67 at time 10, as illustrated with an arrow labeled with “2”. This bid will set the minimum price for item 2 for the remaining duration of the auction. Pricing function for item 3 will also be modified: as the last item, item 3 will get all the benefits during next pricing steps from the batch sale function 104.

The example embodiments of FIGS. 9 and 10 to 18 illustrated various concepts relating to the batch sale function 104, and these concepts will be further explained in the following.

In an example embodiment, the one or more memories 108 further store instructions 110, that, when executed by the one or more processors 102, cause the apparatus 100 to set the batch sale function 104 determining pricing control for the batch before the deadline-optimized auction 106 of the batch commences such that a batch price curve for the batch is set, and item price curves are set for each item belonging to the batch.

In an example embodiment, the one or more memories 108 further store instructions 110, that, when executed by the one or more processors 102, cause the apparatus 100 to set the batch price curve such that the batch price curve determines the behavior of the pricing control between a starting batch price and a minimum batch price according to a continuous function, and setting of the item price curves such that for each item the item price curve determines the behavior of the pricing control between a starting item price and a minimum item price according to a continuous function.

In an example embodiment, the one or more memories 108 further store instructions 110, that, when executed by the one or more processors 102, cause the apparatus 100 to cause reception of a bid for at least one item belonging to the batch, the bid becoming effective at a predetermined bid time between the present and the deadline, and to modify 134 at least one item price curve of at least one item of the batch during the auction between the present and the predetermined bid time by the batch sale function 104 such that the prices of the items combined at least match a minimum batch price set for the batch during the auction 106. In an example embodiment, the one or more memories 108 further store instructions 110, that, when executed by the one or more processors 102, cause the apparatus 100 to cause reception of a bid for at least one item belonging to the batch, the bid becoming effective at a predetermined bid time between the present and the deadline, and to modify 134 at least one item price curve of at least one item of the batch during the auction 106 between the predetermined bid time and the deadline by the batch sale function 104 such that the prices of the items combined at least match a minimum batch price set for the batch during the auction 106.

In an example embodiment, the one or more memories 108 further store instructions 110, that, when executed by the one or more processors 102, cause the apparatus 100 to set the batch sale function determining pricing control for the batch before the deadline-optimized auction 106 of the batch commences such that an item-specific sale function determining pricing control of the specific item is set for at least one item.

In an example embodiment, the one or more memories 108 further store instructions 110, that, when executed by the one or more processors 102, cause the apparatus 100 to modify 134 the at least one price of the at least one item of the batch during the auction 106 by the batch sale function 104 such that the item-specific sale function determining pricing control of the specific item is changed for the at least one item.

In an example embodiment, the one or more memories 108 further store instructions 110, that, when executed by the one or more processors 102, cause the apparatus 100 to cause reception of a bid for at least one item belonging to the batch, the bid becoming effective at a predetermined bid time between the present and the deadline, and to cause a graphical visualization of the bid in a timeline illustrating the pricing control of the item in a form of a pricing curve of the at least one item.

In an example embodiment, the one or more memories 108 further store instructions 110, that, when executed by the one or more processors 102, cause the apparatus 100 to cause a graphical aid for seller 120 to select the batch sale function 104 from among a predetermined set, and to adjust parameters of the batch sale function 104.

In an example embodiment, the one or more memories 108 further store instructions 110, that, when executed by the one or more processors 102, cause the apparatus 100 to set the batch sale function 104 determining the pricing control for the batch and for the plurality of the items belonging to the batch before the auction 106 with the deadline commences such that the auction 106 with the deadline operates according to the reverse auction principle, wherein each item belonging to the batch has a starting item price, and the pricing control is such that the prices are lowered during the auction 106 towards a minimum item price, and to modify 134 the at least one price of the at least one item belonging to the batch during the auction 106 by the batch sale function 106 such that the item price falls during the auction, but that at all times during the auction 106 the combined item prices remain above a minimum batch price.

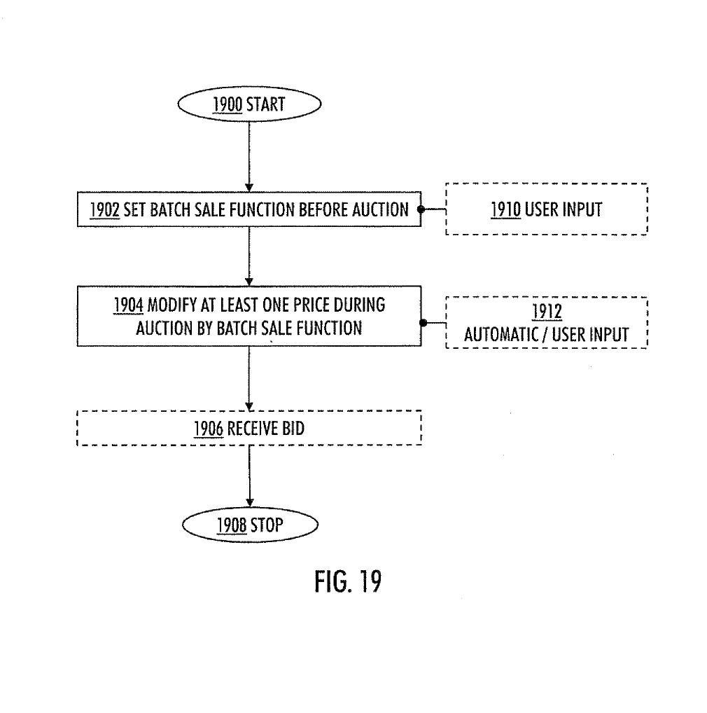

Next, example embodiments of a method will be described with reference to FIG. 19. Other functions, not described in this application, may also be executed between the operations or within the operations. Some of the operations or parts of the operations may also be left out or replaced by a corresponding operation or part of the operation. The method starts in 1900.

In 1902, a batch sale function determining pricing control for a batch and for a plurality of items belonging to the batch is set before an auction with a deadline commences.

In 1904, at least one price of at least one item belonging to the batch is modified during the auction by the batch sale function.

The method ends in 1908.

The embodiments of the earlier described apparatus 100 may also be used to enhance the method. In an example embodiment, the method may be implemented in the apparatus 100 described earlier. In an embodiment, a computer program comprises instructions which, when loaded into the server apparatus 100, cause the apparatus 100 to perform the described process. In an embodiment, a computer-readable storage medium comprises the computer program.

FIG. 19 illustrates some of the earlier described example embodiments, such as those related to the reception 1906 of bids, those related to the reception 1910 of user input to set the batch sale function, and those related to the automatic or used input assisted nature 1912 of the auction.

It will be obvious to a person skilled in the art that, as technology advances, the inventive concept can be implemented in various ways. The invention and its embodiments are not limited to the example embodiments described above but may vary within the scope of the claims.

1. An apparatus comprising:
one or more processors, and
one or more memories storing instructions, that, when executed by the one or more processors, cause the apparatus to:
set a batch sale function determining pricing control for a batch and for a plurality of items belonging to the batch before an auction with a deadline commences; and
modify at least one price of at least one item belonging to the batch during the auction by the batch sale function.

2. The apparatus of claim 1, wherein the one or more memories further store instructions, that, when executed by the one or more processors, cause the apparatus to:
cause the auction of the batch such that buyer candidates consider items as separate.

3. The apparatus of claim 1, wherein the one or more memories further store instructions, that, when executed by the one or more processors, cause the apparatus to:
move the deadline either earlier or later during the auction by the batch sale function.

4. The apparatus of claim 1, wherein the one or more memories further store instructions, that, when executed by the one or more processors, cause the apparatus to perform at least one of the following:
cause reception of user input for setting the batch sale function before the auction commences;
cause reception of user input for adjusting the batch sale function during the auction;
cause automatic adjustment of the batch sale function during the auction;
cause automatic utilization of the batch sale function during the auction;
cause automatic utilization of the batch sale function during the auction, assisted by reception of user input for adjusting the batch sale function.

5. The apparatus of claim 1, wherein the one or more memories further store instructions, that, when executed by the one or more processors, cause the apparatus to:
set the batch sale function determining pricing control for the batch before the deadline-optimized auction of the batch commences such that a minimum batch price during the auction is set for the batch.

6. The apparatus of claim 1, wherein the one or more memories further store instructions, that, when executed by the one or more processors, cause the apparatus to:
set the batch sale function determining pricing control for the batch before the deadline-optimized auction of the batch commences such that at least one minimum item price during the auction is set for at least one item belonging to the batch.

7. The apparatus of claim 1, wherein the one or more memories further store instructions, that, when executed by the one or more processors, cause the apparatus to:
set the batch sale function determining pricing control for the batch before the deadline-optimized auction of the batch commences such that minimum item prices during the auction are set for all items belonging to the batch, and a minimum batch price during the auction is automatically set for the batch based on the minimum item prices for all items belonging to the batch.

8. The apparatus of claim 1, wherein the one or more memories further store instructions, that, when executed by the one or more processors, cause the apparatus to:
set the batch sale function determining pricing control for the batch before the deadline-optimized auction of the batch commences such that a starting batch price is set for the batch.

9. The apparatus of claim 1, wherein the one or more memories further store instructions, that, when executed by the one or more processors, cause the apparatus to:
set the batch sale function determining pricing control for the batch before the deadline-optimized auction of the batch commences such that a starting item price is set for at least one item belonging to the batch.

10. The apparatus of claim 1, wherein the one or more memories further store instructions, that, when executed by the one or more processors, cause the apparatus to:
set the batch sale function determining pricing control for the batch before the deadline-optimized auction of the batch commences such that starting item prices during the auction are set for all items belonging to the batch, and a starting batch price during the auction is automatically set for the batch based on the starting item prices for all items belonging to the batch.

11. The apparatus of claim 1, wherein the one or more memories further store instructions, that, when executed by the one or more processors, cause the apparatus to:
set the batch sale function determining pricing control for the batch before the deadline-optimized auction of the batch commences such that a batch price curve for the batch is set, and item price curves are set for each item belonging to the batch.

12. The apparatus of claim 11, wherein the one or more memories further store instructions, that, when executed by the one or more processors, cause the apparatus to:
set the batch price curve such that the batch price curve determines the behavior of the pricing control between a starting batch price and a minimum batch price according to a continuous function, and setting of the item price curves such that for each item the item price curve determines the behavior of the pricing control between a starting item price and a minimum item price according to a continuous function.

13. The apparatus of claim 11, wherein the one or more memories further store instructions, that, when executed by the one or more processors, cause the apparatus to:
cause reception of a bid for at least one item belonging to the batch, the bid becoming effective at a predetermined bid time between the present and the deadline; and
modify at least one item price curve of at least one item of the batch during the auction between the present and the predetermined bid time by the batch sale function such that the prices of the items combined at least match a minimum batch price set for the batch during the auction.

14. The apparatus of claim 11, wherein the one or more memories further store instructions, that, when executed by the one or more processors, cause the apparatus to:
cause reception of a bid for at least one item belonging to the batch, the bid becoming effective at a predetermined bid time between the present and the deadline; and
modify at least one item price curve of at least one item of the batch during the auction between the predetermined bid time and the deadline by the batch sale function such that the prices of the items combined at least match a minimum batch price set for the batch during the auction.

15. The apparatus of claim 1, wherein the one or more memories further store instructions, that, when executed by the one or more processors, cause the apparatus to:
modify the at least one price of the at least one item of the batch during the auction by the batch sale function such that at least one item price of at least one item belonging to the batch becomes negative, causing a payment to a buyer for buying the item with the negative price, but the prices of the items combined at least match a minimum batch price set for the batch during the auction.

16. The apparatus of claim 1, wherein the one or more memories further store instructions, that, when executed by the one or more processors, cause the apparatus to:
set the batch sale function determining pricing control for the batch before the deadline-optimized auction of the batch commences such that an item-specific sale function determining pricing control of the specific item is set for at least one item.

17. The apparatus of claim 16, wherein the one or more memories further store instructions, that, when executed by the one or more processors, cause the apparatus to:
modify the at least one price of the at least one item of the batch during the auction by the batch sale function such that the item-specific sale function determining pricing control of the specific item is changed for the at least one item.

18. The apparatus of claim 1, wherein the one or more memories further store instructions, that, when executed by the one or more processors, cause the apparatus to:
cause reception of a bid for at least one item belonging to the batch, the bid becoming effective at a predetermined bid time between the present and the deadline; and
cause a graphical visualization of the bid in a timeline illustrating the pricing control of the item in a form of a pricing curve of the at least one item.

19. The apparatus of claim 1, wherein the one or more memories further store instructions, that, when executed by the one or more processors, cause the apparatus to:
cause a graphical aid for seller to select the batch sale function from among a predetermined set, and to adjust parameters of the batch sale function.

20. The apparatus of claim 1, wherein the one or more memories further store instructions, that, when executed by the one or more processors, cause the apparatus to:
set the batch sale function determining the pricing control for the batch and for the plurality of the items belonging to the batch before the auction with the deadline commences such that the auction with the deadline operates according to the reverse auction principle, wherein each item belonging to the batch has a starting item price, and the pricing control is such that the prices are lowered during the auction towards a minimum item price; and
modify the at least one price of the at least one item belonging to the batch during the auction by the batch sale function such that the item price falls during the auction, but that at all times during the auction the combined item prices remain above a minimum batch price.

21. The apparatus of claim 1, wherein the apparatus comprises at least one of the following: a computer, a server, a computer system, a cluster of computers, a network element in a cloud computing environment, a node of a peer-to-peer computing environment, a node of a hybrid peer-to-peer computing environment, any one of the previous operated by a service provider providing an on-line electronic environment for the auction, a particular network computer, a particular stand-alone computer, a server of a system providing an online environment for the auction of the batch by communicating with clients.

22. A method comprising:
setting a batch sale function determining pricing control for a batch and for a plurality of items belonging to the batch before an auction with a deadline commences; and
modifying at least one price of at least one item belonging to the batch during the auction by the batch sale function.
